(19) United States
(12) Patent Application Publication
(10) Pub. No.: US 2004/0191612 A1
(43) Pub. Date: Sep. 30, 2004

(54) Prismatic battery

(76) Inventors: Hiroyuki Akita, Kobe-city (JP); Hideki Kitao, Kobe-city (JP); Kouichi Satoh, Kobe-city (JP); Atsuhiro Funahashi, Toyonaka-city (JP); Toshiyuki Nohma, Kobe-city (JP)

Correspondence Address: KUBOVCIK & KUBOVCIK, SUITE 710, 900 17TH STREET NW, WASHINGTON, DC, 20006

(21) Appl. No.: 10/812,169

(22) Filed: Mar. 30, 2004

(30) Foreign Application Priority Data
Mar. 31, 2003 (JP) 2003-093306

(51) Int. Cl. H01M 6/10; H01M 2/26; H01M 2/36

(52) U.S. Cl. 429/94; 429/176; 429/161; 429/211; 429/72; 29/623.4

(57) ABSTRACT

A prismatic battery wherein a wound electrode (2) is housed in a battery can (1) including a sealing plate (12) fixed onto an opening of a prismatic case (11) with the outer surface of the electrode (2) aligned with the bottom of the prismatic case (11). Current collector plates (3), (30) are placed at both ends of the wound electrode (2) where edges (21), (22) of a pair of positive and negative electrodes project. The current collector plates (3), (30) are connected to a pair of positive and negative electrode terminals (4), (40). The current collector plates (3), (30) and the electrode terminals (4), (40) are connected by flexible flexible lead members (5), (50).

### FIELD OF THE INVENTION

The present invention relates to a prismatic battery comprising a wound electrode housed in a prismatic battery can.

### BACKGROUND OF THE INVENTION

A lithium secondary battery having a high energy density (Wh/Kg) has recently been developed as a power source for portable electronic equipment, electric vehicles, and the like. A prismatic battery has especially become attractive because of a high volume energy density (Wh/P).

A prismatic battery as shown in FIG. 6 houses a wound electrode (8), which is a power generation element, sideways in a rectangular parallelepiped case (80) (See Japanese Patent Laid-open Publication No. 2002-93402). L-shaped current collector members (9), (90) are connected to opposite ends of the electrode (8). A pair of positive and negative terminals (91), (92) are formed on respective current collector members (9), (90) to take out generated power.

A sealing plate (not shown in FIG. 6) is fixed on an opening of the case (80). The terminals (91), (92) pass through two holes formed in the sealing plate which are electrically insulated and airtight and power is taken out from the ends of the terminals.

In the prismatic battery shown in FIG. 6, the positions of the current collector members (9), (90) depend on the size of the electrode (8). As a result, the positions of the terminals (91), (92) with respect to the case (80) are determined. As described above, the sealing plate is secured to the opening of the case (80), and the positions of the holes for the terminals are fixed with respect to the case (80). Therefore, very precise control of the locations of the current collector members (9), (90) relative to the electrode (8) and of the locations of the terminals (91), (92) on the current collector members (9), (90) is required to pass the terminals (91), (92) through the holes of the sealing plate.

The ends of the electrode bend when the terminals (91), (92) are pushed against the electrode because the ends of the electrode comprise very thin positive and negative electrode current collectors aligned at regular intervals and which project from the ends of the electrode. As a result, the position of or distance between the current collector members (9), (90) may change.

A structure having plural protrusions formed on a connection area connecting the current collector members (9), (90) and the ends of the electrode (8) for increasing the contact area between the current collector members (9), (90) and the electrodes (8) by pressing the protrusions into the ends of the electrode (8) is known to increase current collecting efficiency. However, when the structure is applied to the prismatic battery shown in FIG. 6, the force with which the current collector members (9), (90) are pressed changes the depth to which the protrusions project into the end of the electrodes (8) to cause the positions of the current collector members (9), (90) to vary widely.

As explained above, it is impossible to avoid variations in the space or distance between the current collector members (9), (90). Therefore, it is not possible to avoid misalignment between the terminals (91), (92) and the holes formed in the sealing plate. This makes it very difficult to assemble the battery. If the terminals (91), (92) are forced into the holes, welds between the current collector members (9), (90) and the electrodes are stressed to cause the welds to peel.

### OBJECT OF THE INVENTION

An object of the present invention is to provide a prismatic battery which is easy to assemble and in which there are no unnecessary stresses formed inside of the battery after it is assembled.

### SUMMARY OF THE INVENTION

The present invention relates a prismatic battery wherein a wound electrode (2) is housed in a battery can (1) comprising a sealing plate (12) fixed onto an opening of a prismatic case (11) and the outer surface of the electrode (2) is aligned with the bottom of the prismatic case (11). Current collector plates (3), (30) are placed at both ends of the wound electrode (2) where edges (21), (22) of a pair of positive and negative electrodes project. The current collector plates (3), (30) are connected to electrode terminals (4), (40) comprising a pair of a positive and negative electrode terminals. The current collector plates (3), (30) and the electrode terminals (4), (40) are connected by flexible lead members (5), (50).

### BRIEF DESCRIPTION OF THE DRAWINGS

FIG. 1 is a perspective view of the prismatic battery of the present invention.

FIG. 2 is a perspective view of the wound electrode and the current collector plates of the prismatic battery of the present invention.

FIG. 3 is an exploded perspective view of the prismatic battery of the present invention.

FIG. 4 is a partial front elevation showing a connection part of the electrode terminal and the wound electrode of the prismatic battery of the present invention.

FIG. 5 is a partial front elevation showing a connection part of the electrode terminal and the wound electrode in another embodiment of the prismatic battery of the present invention.

FIG. 6 is a perspective view of a conventional prismatic battery.

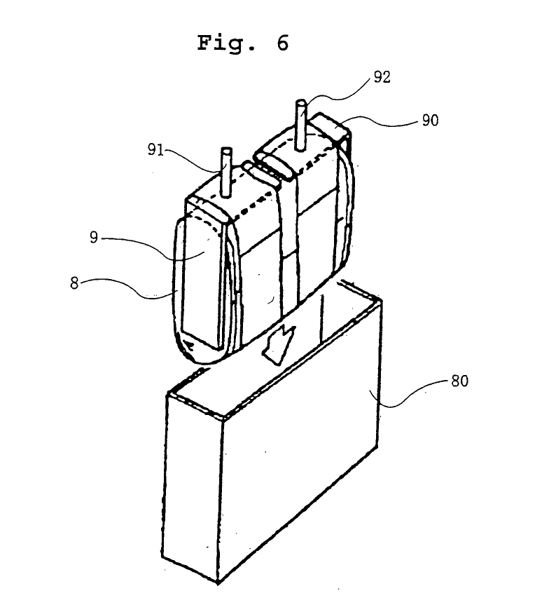

[Explanation of Elements]

1: battery can

11: prismatic case

12: sealing plate

13: gas releasing valve

14: stopper

2: wound electrode

21, 22: edges of electrode

3, 30: current collector plates (plates)

32: projection

33: pouring opening

4, 40: electrode terminal

41: screw member

42: flange

43, 46: insulator

47: washer

48: spring washer

49: nut

44, 45: O-ring

5, 50: lead members

6, 60: insulation

61: U-shaped cut-out

### DETAILED EXPLANATION OF THE INVENTION

In the prismatic battery of the present invention, one end of each of the lead members (5), (50) is welded to the current collector plates (3), (30) and another end of each of the lead members (5), (50) is welded to the electrode terminals (4), (40) or is held by the electrode terminals (4), (40).

Even if there happens to be a variations in the positions of the current collector plates (3), (30) on the electrode (2), the variations can be overcome by bending or deformation of the lead members (5), (50) at a step of assembling the battery because the current collector plates (3), (30) and the electrode terminals (4), (40) are connected by the flexible lead members (5), (50).

Therefore, a process to connect the current collector plates (3), (30) and the electrode terminals (4), (40) with the lead members (5), (50) is easy. Furthermore, connected areas of the current collector plates (3), (30) and the lead members (5), (50) and the electrode terminals (4), (40) and the lead members (5), (50) do not have stress.

As a concrete embodiment, one or more protrusions projecting toward the edges (21), (22) of the electrode (2) are formed on each of the current collector plates (3), (30). According to this structure, during assembly when the current collector plates (3), (30) are pressed against the edges (21), (22) of the electrode (2) the protrusions formed on the current collector plates (3), (30) are forced into the edges (21), (22) and contact area is increased. As a result, current is collected efficiently by the current collector plates (3), (30).

In another embodiment, insulation members (6), (60) are inserted between the current collector plates (3), (30) and side walls of the prismatic case (11), and at least one insulation member (6) is resilient or has elasticity. According to this structure, a variation in the space between the current collector plates (3), (30) and the side walls of the prismatic case (11), which is created when the protrusions on the current collector plates (3), (30) are forced into the edges (21), (22) of the electrode (2), can be adjusted by elastic deformation of the insulation member (6).

In a further embodiment, at least one opening or inlet which forms an electrolyte pouring opening (33) is provided in each of the current collector plates (3), (30). At least one of insulation members (6), (60) has a U-shape cut-out (61) to expose the opening (33). According to this structure, an electrolyte which is poured into the prismatic case (11) can be supplied to the electrode (2) through the opening (33).

In a still further embodiment of the present invention, the prismatic battery is manufactured by pressing and connecting the current collector plates (3), (30) having the one or more protrusions (32), (32) formed thereon against both ends of the wound electrode (2). In the wound electrode (2) a separator is sandwiched between a positive electrode and a negative electrode and spirally wound such that respective edges (21), (22) of the positive electrode and negative electrode project from axial ends of the wound electrode (2). When the current collector plates (3), (30) are pressed against the ends of the wound electrode (2), protrusions (32), (32) are forced into the edges (21), (22) of the wound electrode (2).

Separately, the positive and negative electrode terminals (4), (40) are attached to the sealing plate (12). Top portions of the flexible lead members (5), (50) are then connected onto a back side of the electrode terminals (4), (40) and the flexible lead members (5), (50) are bent such that the base portions of the flexible lead members (5), (50) are separated by a distance corresponding to the distance between the current collector plates (3), (30) attached to the wound electrode (2). The base portions of the flexible lead members (5), (50) are then welded onto the surfaces of the current collector plates (3), (30) to produce an assembly of the wound electrode (2), sealing plate (12) and electrode terminals (4), (40).

The insulators (6), (60) are placed on the outside of the current collector plates (3), (30) and the assembly is placed into the prismatic case (11) with insulators (6), (60) on the sides of the prismatic case (11). The sealing plate (12) is then welded onto the open top of the prismatic case (11) and an electrolyte is introduced to the inside of the prismatic case (11) and the case is sealed to produce the prismatic battery.

### EFFECTS OF THE INVENTION

A prismatic battery of the invention can be easily assembled and can avoid stress from occurring inside of the battery during assembly.

### DESCRIPTION OF PREFERRED EMBODIMENT

Embodiments of the present invention are explained in detail below with reference to the drawings. It is of course understood that the present invention is not limited to these embodiments and can be modified within the spirit and scope of the appended claims.

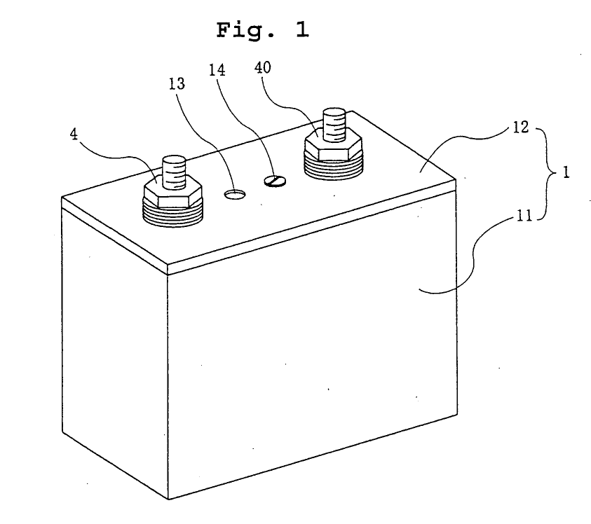

A prismatic battery of the invention comprises a rectangular parallelepiped battery can (1) which comprises an aluminum prismatic case (11) and an aluminum sealing plate (12) welded onto the prismatic case (11) as shown in FIG. 1. Typical outer dimensions of the battery can (1) are, for example, 50 mm×30 mm×10 mm.

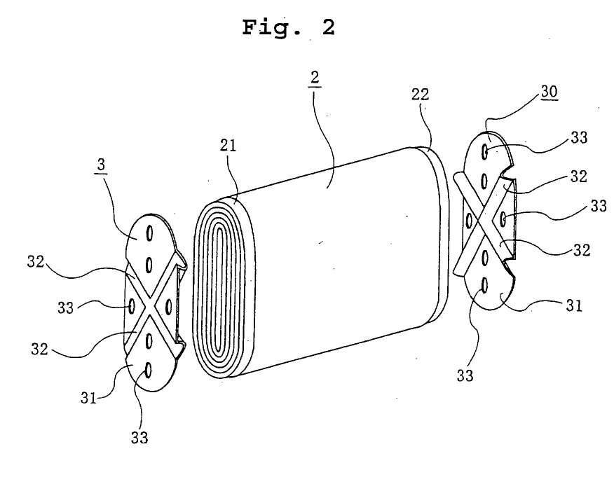

A wound electrode (2) is housed in the battery can (1) as shown in FIG. 2. A positive electrode and a negative electrode of the wound electrode (2) are connected to a pair of electrode terminals (4), (40) as shown in FIG. 1. Power can be taken out from the terminals (4), (40).

A gas releasing valve (13) which operates when internal pressure of the battery increases and a stopper (14) to close an opening through which an electrolyte is poured into the battery can (1) during assembly of the battery are provided on the sealing plate (12).

The wound electrode (2) comprises a separator sandwiched between a positive electrode and a negative electrode and spirally wound as shown in FIG. 2. Edges (21), (22) of the positive and negative electrodes project from opposite ends of the electrode (2). Current collector plates (3), (30) are in contact with the edges (21), (22) of the positive and negative electrodes.

The positive electrode comprises a positive active material layer including, for example, lithium cobalt oxide formed on a surface of a current collector made of an aluminum foil. The negative electrode comprises a negative active material layer including a carbon powder formed on a surface of a current collector made of a copper foil. The active material layers are not coated on the edges of the positive and negative electrodes. The positive and negative electrodes are wound so that the uncoated portions project axially beyond the edges of the separator.

A pair of current collector plates (3), (30) having an elliptical, flat platelike body (31) and formed in a radial pattern with a plurality of protrusions (32) having an arc shape cross section and projecting in the direction of the edges (21), (22) of the electrode (2) and having a plurality of pouring openings (33) are connected to opposite ends of the electrode (2). The current collector plate (3) on the positive electrode side is made of aluminum, and the current collector plate (30) on the negative electrode side is made of copper.

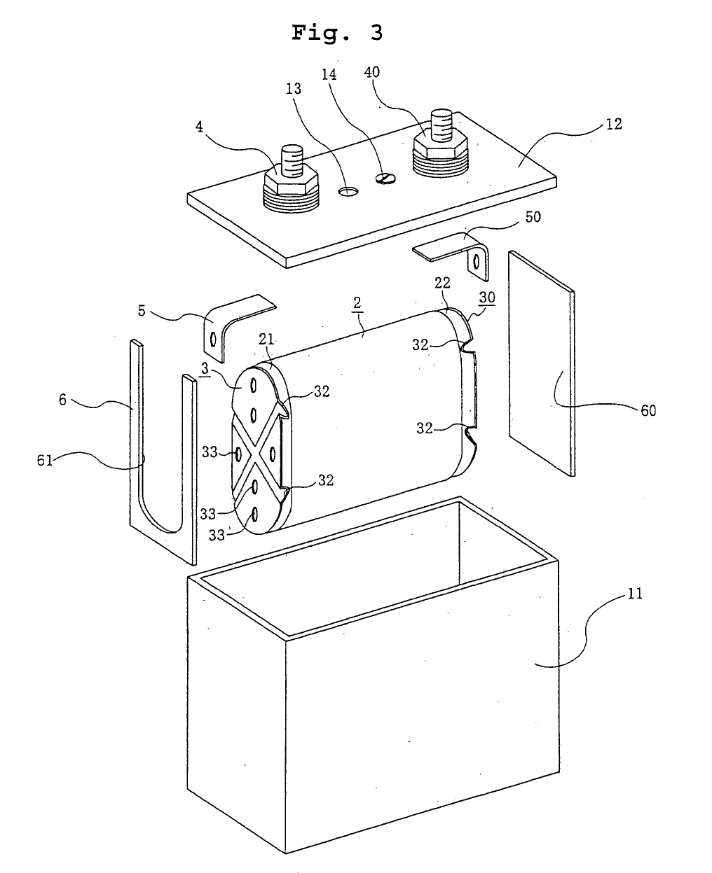

As shown in FIG. 3, the wound electrode (2) in contact with the current collector plates (3), (30) is placed in the prismatic case (11) such that the outer surface of the electrode (2) is aligned with the bottom of the prismatic case (11).

Striplike lead members (5), (50) having an elbow-shaped bend are placed on both ends of the electrode (2) to which the current collector plates (3), (30) are connected. One end of each lead member (5), (50) is welded to a current collector plate (3), (30) and the other end of each lead member (5), (50) is welded to base ends of electrode terminals (4), (40). The lead member (5) on the positive electrode side is made of aluminum, and the lead member (50) on the negative electrode side is made of copper.

Sheet-like insulators (6), (60) are inserted between the current collector plates (3), (30) and side walls of the prismatic case (11) to insulate the current collector plates (3), (30) from the prismatic case (11). One insulator (6) is made of an elastic or resilient material, for example, fluororesin, and has a U-shaped opening (61) which is open toward the sealing plate (12) side, i.e., is in the shape of a horseshoe. The other side of the insulator (60) is made of polypropylene and is substantially rectangular.

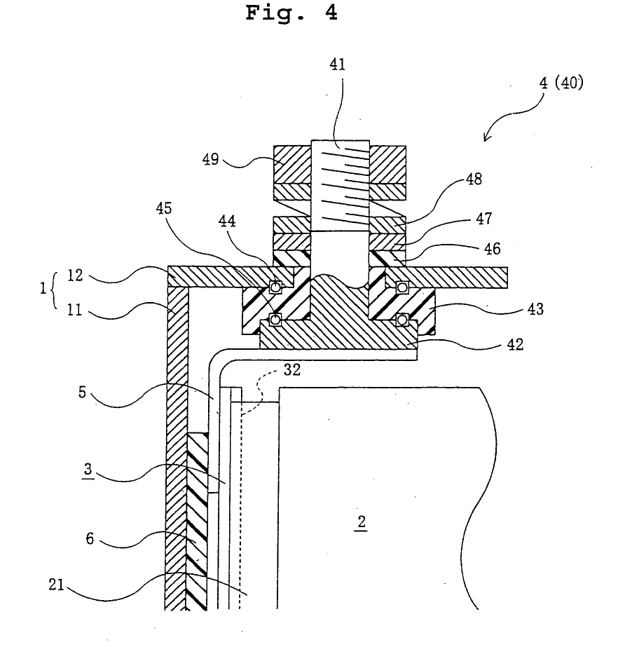

As shown in FIG. 4, the electrode terminal (4) on the positive electrode side comprises an aluminum screw member (41) having a flange (42). The screw member. (41) passes through the sealing plate (12) and the end of the screw member (41) is fixed with a nut (49). A first insulator member (43) and a second insulator member (46) which are made of polypropylene are placed around the screw member (41) on both sides of the sealing plate (12). “O”-shaped rings are placed on both sides, i.e., the sealing plate (12) side and the flange (42) side, of the first insulator member (43).

A flat washer (47) and a spring washer (48) are inserted between the second insulator member (46) and the nut (49). When the nut (49) is tightened, the flange (42) and the flat washer (47) press against the first insulator member (43) and the second insulator member (46) to keep the battery airtight.

As described above and referring to FIG. 4, one end of the lead member (5) is welded to the surface of the current collector (3) and the other end of the lead member (5) is welded to the flange (42) of the screw member (41).

The structure of the electrode terminal (40) on the negative electrode side is the same as that of the electrode terminal (4) except that the screw member (41) is made of copper.

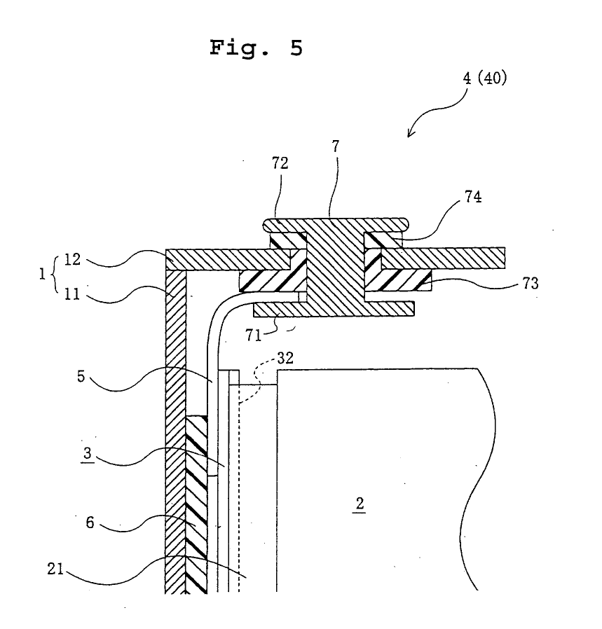

Another possible structure for the electrode terminals (4), (40), is shown in FIG. 5. In this structure of the electrode terminals (4), (40), sealing plate (12) is sandwiched by a first insulator member (73) and a second insulator member (74) which are fastened with a terminal member (7) having a flange (71) as a rivet. The first insulator member (73) and the second insulator member (74) are pressed between the flange (71) and a caulking part (72), and an end of the lead member (5) is held between the flange (71) and the first insulator member (73). This structure can reduce steps of assembling the battery and keeps the battery airtight excellently because the terminal member (7) is riveted to the sealing plate (12).

When the prismatic battery is assembled, the current collector plates (3), (30) are pressed against both ends of the wound electrode (2) and are welded by a laser beam. Protrusions (32), (32) formed on the current collector plates (3), (30) are forced into the edges (21), (22) of the wound electrode (2) and a large contact area between the current collector plates (3), (30) and the wound electrode (2) can be obtained.

A pair of (positive and negative) electrode terminals (4), (40) are fabricated on the sealing plate (12).

Then top portions of the lead members (5), (50) are welded onto a back side of the flanges of the electrode terminals (4), (40). The lead members (5), (50) are bent to correspond to the distance between the current collector plates (3), (30) attached to the wound electrode (2). Base portions of the lead members (5), (50) are then welded onto the surfaces of the current collector plates (3), (30) to produce an assembly of the wound electrode (2), sealing plate (12) and electrode terminals (4), (40).

The insulators (6), (60) are placed on the outside of the current collector plates (3), (30) and the assembly is placed in the prismatic case (11). The sealing plate (12) is then welded onto the prismatic case (11). Positions of the lead members (5), (50) and the sealing plate (12) relative to the wound electrode (2) have been adjusted relative to the prismatic case (11). Therefore, the sealing plate (12) can be perfectly aligned on the opening of the prismatic case (11).

The electrolyte is poured through an opening of the sealing plate (12). The electrolyte is supplied into the wound electrode (2) through the cut portion (61) of the insulator (6) and the pouring opening (33) of the current collector (3). Finally the opening is closed by the stopper (14) to complete assembly of the battery.

### ADVANTAGES OF THE INVENTION

The prismatic battery can adjust the positions of the wound electrode (2), the electrode terminals (4), (40), the prismatic case (11) and the sealing plate (12) by bending of the lead members (5), (50) during the steps of assembly and thus the assembling of the battery is easy, and after being assembled no unreasonable stress is applied to the lead members (5), (50). Therefore, there is not a problem of peeling of the welds between the lead members (5), (50), the current collector plates (3), (30) and the electrode terminals (4), (40).

Volume efficiency of batteries when two or more batteries are used together can be increased because two electrode terminals (4), (40) for a positive electrode and a negative electrode are arranged on the sealing plate (12) and the prismatic batteries can be closely arranged. When the battery is vibrated, vibrations can be absorbed by the insulator (6) because the insulator (6) is made of an elastic material.

What is claimed is:

1. A prismatic battery comprising a wound electrode (2) housed in a battery can (1) and which includes a separator sandwiched between positive and negative electrodes, the battery can comprising a prismatic case (11) having an opening at an upper portion thereof and a sealing plate (12) fixed onto the opening of the prismatic case (11) and comprising a pair of positive and negative electrode terminals (4), (40), an outer surface of the electrode (2) being aligned with the bottom of the prismatic case (11); current collector plates (3), (30) arranged at ends of the wound electrode (2) and connected to respective edges of said positive and negative electrodes, the current collector plates (3), (30) being connected to said pair of positive and negative electrode terminals (4), (40) by flexible lead members (5), (50).

2. The prismatic battery according to claim 1, wherein one end of each of the lead members (5), (50) is welded to the current collector plates (3), (30) and another end of each of the lead members (5), (50) is welded to said pair of positive and negative electrode terminals (4), (40).

3. The prismatic battery according to claim 1, wherein one end of each of the lead members (5), (50) is welded to the current collector plates (3), (30) and another end of each of the lead members (5), (50) is held by said pair of positive and negative electrode terminals (4), (40).

4. The prismatic battery according to claim 1, wherein one or more protrusions projecting toward the edges of said positive and negative electrodes of the electrode (2) are formed on each of the current collector plates (3), (30).

5. The prismatic battery according to claim 2, wherein one or more protrusions projecting toward the edges of said positive and negative electrodes of the electrode (2) are formed on each of the current collector plates (3), (30).

6. The prismatic battery according to claim 3, wherein one or more protrusions projecting toward the edges of said positive and negative electrodes of the electrode (2) are formed on each of the current collector plates (3), (30).

7. The prismatic battery according to claim 1, wherein insulation members (6), (60) are arranged between the current collector plates (3), (30) and sides of the prismatic case (11) and at least one insulation member is resilient or has elasticity.

8. The prismatic battery according to claim 2, wherein insulation members (6), (60) are arranged between the current collector plates (3), (30) and sides of the prismatic case (11) and at least one insulation member is resilient or has elasticity.

9. The prismatic battery according to claim 3, wherein insulation members (6), (60) are arranged between the current collector plates (3), (30) and sides of the prismatic case (11) and at least one insulation member is resilient or has elasticity.

10. The prismatic battery according to claim 4, wherein insulation members (6), (60) are arranged between the current collector plates (3), (30) and sides of the prismatic case (11) and at least one insulation member is resilient or has elasticity.

11. The prismatic battery according to claim 5, wherein insulation members (6), (60) are arranged between the current collector plates (3), (30) and sides of the prismatic case (11) and at least one insulation member is resilient or has elasticity.

12. The prismatic battery according to claim 6, wherein insulation members (6), (60) are arranged between the current collector plates (3), (30) and sides of the prismatic case (11) and at least one insulation member is resilient or has elasticity.

13. The prismatic battery according to claim 7, wherein at least one opening or inlet which forms an electrolyte pouring opening (33) is provided in each of the current collector plates (3), (30) and at least one of the insulation members (6), (60) has a U-shape cut-out (61) to expose the at least one opening (33).

14. The prismatic battery according to claim 8, wherein at least one opening or inlet which forms an electrolyte pouring opening (33) is provided in each of the current collector plates (3), (30) and at least one of the insulation members (6), (60) has a U-shape cut-out (61) to expose the at least one opening (33).

15. The prismatic battery according to claim 9, wherein at least one opening or inlet which forms an electrolyte pouring opening (33) is provided in each of the current collector plates (3), (30) and at least one of the insulation members (6), (60) has a U-shape cut-out (61) to expose the at least one opening (33).

16. The prismatic battery according to claim 10, wherein at least one opening or inlet which forms an electrolyte pouring opening (33) is provided in each of the current collector plates (3), (30) and at least one of the insulation members (6), (60) has a U-shape cut-out (61) to expose the at least one opening (33).

17. The prismatic battery according to claim 11, wherein at least one opening or inlet which forms an electrolyte pouring opening (33) is provided in each of the current collector plates (3), (30) and at least one of the insulation members (6), (60) has a U-shape cut-out (61) to expose the at least one opening (33).

18. The prismatic battery according to claim 12, wherein at least one opening or inlet which forms an electrolyte pouring opening (33) is provided in each of the current collector plates (3), (30) and at least one of the insulation members (6), (60) has a U-shape cut-out (61) to expose the at least one opening (33).

19. A method of manufacturing a prismatic battery comprising:
providing a wound electrode (2) comprising a separator sandwiched between a positive electrode and a negative electrode and spirally wound such that respective edges (21), (22) of the positive electrode and negative electrode project from axial ends of the wound electrode (2);
pressing and connecting current collector plates (3), (30) having one or more protrusions (32), (32) formed thereon against both ends of the wound electrode (2) such that the protrusions (32), (32) are forced into the edges (21), (22) of the wound electrode (2);
providing a sealing plate (12) for sealing an end of the prismatic battery, said sealing plate (12) having a front side and a back side, and attaching a pair of positive and negative electrode terminals (4), (40) to the sealing plate (12);
providing flexible lead members (5), (50) and connecting first top portions of the flexible lead members (5), (50) onto a back side of the electrode terminals (4), (40);
bending the flexible lead members (5), (50) to provide second base portions of the flexible lead members (5), (50) separated by a distance corresponding to the distance between the current collector plates (3), (30) attached to the wound electrode (2);
welding said second base portions of the flexible lead members (5), (50) onto the surfaces of the current collector plates (3), (30) to produce an assembly of the wound electrode (2), sealing plate (12) and electrode terminals (4), (40);
providing a prismatic case (11) having an open top;
placing insulators (6), (60) on the outside of the current collector plates (3), (30) and placing the assembly into the prismatic case (11) with insulators (6), (60) on the sides of the prismatic case (11);
welding the sealing plate (12) onto the open top of the prismatic case (11); and
introducing an electrolyte to the inside of the prismatic case (11) and sealing the case to produce said prismatic battery.
